(19) United States
(12) Patent Application Publication
(10) Pub. No.: US 2012/0133972 A1
(43) Pub. Date: May 31, 2012

(54) IMAGE FORMING APPARATUS WHICH CAN HANDLE CODE AND CONTROL METHOD THEREOF

(75) Inventor: Tomonori Hayashi, Kawasaki-shi (JP)

(73) Assignee: CANON KABUSHIKI KAISHA, Tokyo (JP)

(21) Appl. No.: 13/274,024

(22) Filed: Oct. 14, 2011

(30) Foreign Application Priority Data
Nov. 25, 2010 (JP) 2010-262483

(51) Int. Cl. G06K 15/02

(52) U.S. Cl. 358/1.15

(57) ABSTRACT

Information identifying a user who made an instruction to send a document from a personal computer (PC) to an image forming apparatus and to store the document in the image forming apparatus, that is, a user who caused the risk of information leakage to increase could not be identified. Code image data which includes information identifying the user who made the storage instruction and information identifying another user who made a print instruction is printed together with print data.

### BACKGROUND OF THE INVENTION

1. Field of the Invention

The present invention relates to an image forming apparatus which can handle a code and a control method thereof.

2. Description of the Related Art

In order to identify an information leakage path, a technology is known in which a certain type of code such as a two-dimensional code and an electronic watermark is added to a medium such as paper so as to record information indicating duplicated history in the paper medium. However, a code has a limit in the quantity of information and cannot contain all the information. Thus, it is necessary to select a part of the information from all the information desired to be contained in the code. Considering the point, in Japanese Patent Laid-Open No. 2010-136098, two types of information, that is, the latest information and the oldest information, are selected from all the information relating to the history desired to be included in the code. FIG. 1 illustrates transition of a code including the latest user information and the oldest user information in a process in which a plurality of users sequentially copies documents.

However, in Japanese Patent Laid-Open No. 2010-136098, since only information of a user who consistently instructed a printing process such as printing or copying is included in the code, a problem in security is involved.

For example, information of a user who made a storage instruction of a document has not been included in the code. The storage instruction refers to an instruction to send a document from a personal computer (PC) to an image forming apparatus and to cause the image forming apparatus to store the document, for example.

Thus, it was impossible to identify who stored the document in the image forming apparatus after information leakage was found out.

In general, a PC is used by one user, while an image forming apparatus is used by many people. As a result, it is likely that documents are viewed or used by more people, and a risk of information leakage becomes high. From such a viewpoint, information of a user who made a storage instruction of a document in the image forming apparatus should be included in the code.

### SUMMARY OF THE INVENTION

An apparatus according to the present invention is an apparatus having a control unit configured to cause a storage unit to store image data in accordance with a storage instruction, which is an instruction to store the image data, and to cause a printing unit to print the image data in accordance with a print instruction, which is an instruction to print the image data stored in the storage unit, and the printing unit is caused to print, together with the image data, code image data which includes information identifying a user who made the storage instruction and information identifying another user who made the print instruction.

According to the present invention, the information of the user who made the storage instruction of the document in the image forming apparatus can be easily identified.

Further features of the present invention will become apparent from the following description of exemplary embodiments (with reference to the attached drawings).

### BRIEF DESCRIPTION OF THE DRAWINGS

FIG. 1 is a diagram illustrating transition of the oldest user data and the latest user data in a copying process which has been performed;

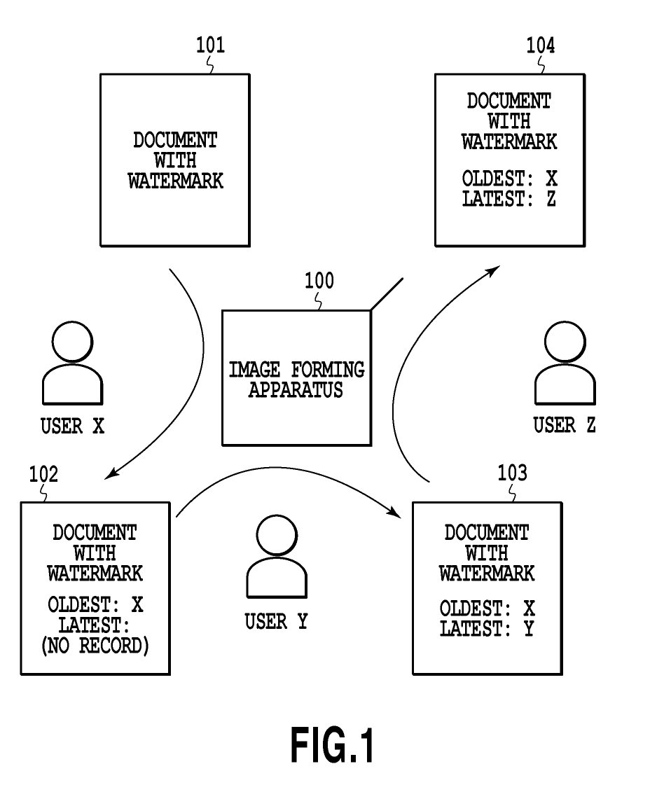

FIG. 2 is a diagram illustrating an example of a configuration of user history data according to the present invention;

FIG. 3 is a diagram illustrating a flowchart of processing of printing print data transmitted from a PC after it is stored in a storage section (box storage) according to the present invention;

FIG. 4 is a diagram illustrating transition of the user history data added to a printed matter according to the present invention;

FIG. 5 is a diagram illustrating a flowchart when the print data stored in a box with a password is to be printed according to the present invention;

FIG. 6 is a diagram showing the relationship of FIGS. 6A and 6B;

FIGS. 6A and 6B are diagrams illustrating a flowchart when a document before copying is scanned by a scanner and the scanned document image data is printed after stored in the box according to the present invention; and

FIG. 7 is a diagram illustrating a configuration example of an image forming apparatus according to the present invention.

### DESCRIPTION OF THE EMBODIMENTS

Embodiments for carrying out the present invention will be described below by using the attached drawings.

In this embodiment, a case in which a code image having an area of a defined size which can include information in a defined quantity is used will be described. The code image refers to image data whose information is encoded in a form of a two-dimensional code or an electronic watermark. It is needless to say that such code image having the defined size includes information in the defined quantity or less.

Further, in this embodiment, the code image having the defined size is assumed to be able to include at least user history data including two types of data. One of the data in the user history data is referred to as the oldest user data and the other as the latest user data. The oldest user data refers to information relating to a user who caused the increased risk of information leakage at the first stage. The latest user data refers to data indicating information relating to a person who copied/printed a paper medium at the last stage. In this embodiment, the terms information and data are used synonymously. The terms storage and memory are also used synonymously.

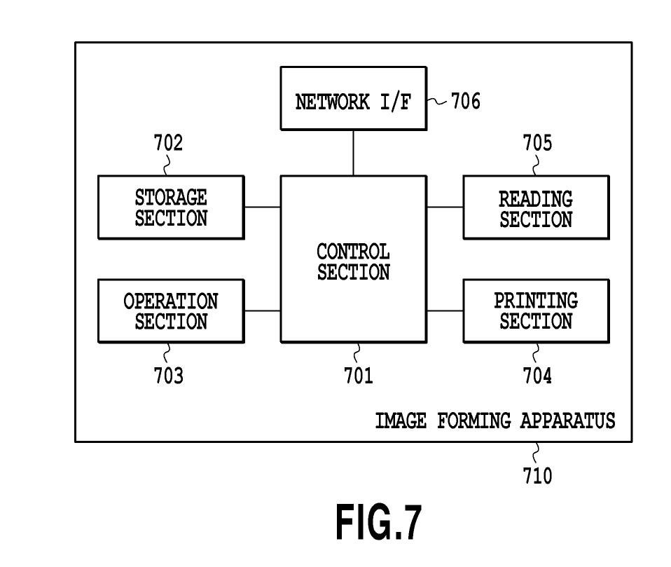

In this embodiment, an example in which a network multifunction printer device (MFP) is used as an image forming apparatus will be described. FIG. 7 is a diagram illustrating a configuration example of an image forming apparatus 710 according to the present invention. The image forming apparatus 710 includes a control section 701, a storage section 702, an operation section 703, a printing section 704, a reading section 705, and a network interface (I/F) 706. The control section 701 is a CPU, for example, and executes various controls in the image forming apparatus. The storage section 702 is a hard disk, a memory or the like, for example, and stores print data and various programs. The operation section 703 is formed of a display and a sensor, for example, and receives an input of an operation instruction from a user. The printing section 704 is a printer engine, for example, and performs processing of printing the print data. The reading section 705 is a scanner, for example, and performs processing of scanning a document and obtaining document image data. The network I/F 706 receives a document (hereinafter described as print data) transmitted from a PC, for example or transmits the print data to another image forming apparatus.

The image forming apparatus 710 is provided with a function of storing the received print data in the storage section 702 in addition to a function of receiving the print data from the PC connected via a network and printing the data by the printing section 704. Also, the image forming apparatus 710 is provided with a function of combining a certain type of information as a code image with the print data and printing it by the printing section 704. Since these configurations are known, explanation will be omitted in this description.

The basic idea of this embodiment is that a user who instructed printing and copying should be included in the oldest user data and the latest user data as premises. However, the outline of this embodiment is that if the storage user who stored the document conducts a risky act (an act to change the state from a so-called closed one to an open one), this storage user is exceptionally set as the oldest user data. Here, the PC is assumed to be in a closed state, since it is used personally, while an image forming apparatus (MFP) is assumed to be in an open state since it is shared by many people.

Subsequently, a method of storing user data included in the user history data will be described. In order to operate the image forming apparatus 710, a user inputs a user ID and a password through the operation section 703 of the image forming apparatus 710. Then, the image forming apparatus checks if the password is correct for the user ID. If it is correct, user ID, which is information which identifies the user who tries to login (hereinafter referred to as a login user in some cases), is stored in the storage section 702 of the image forming apparatus. As a result, login is completed.

Here, the term user information will be defined. The user information may be information which directly identifies the user such as the user ID, the user's name, mail address, contact information or the like, for example. Alternatively, the information may be information which indirectly identifies the user, such as copying time and a machine number of the image forming apparatus which performs copying, for example. Why can these types of information indirectly identify the user? That is because if the copying time is known, who made the copying instruction of the document before copying might be known. For example, who is the user standing in front of the copying machine at that time might be known from a monitoring camera or the like. Also, if the machine number of the image forming apparatus is known, who made the copying instruction of the document before copying might be known. For example, they are the cases in which users who mostly use the image forming apparatus are fixed. The “information which identifies the user” can be also expressed as “information which can be helpful in identifying the user”. In this embodiment, the information which directly identifies the user and the information which indirectly identifies the user described above can be both included in the user information.

As described above, the user information maybe any type as long as it is the information which can be helpful in identifying the user, but in the following, for convenience of description, the example in which the user ID is included as the user information will be described.

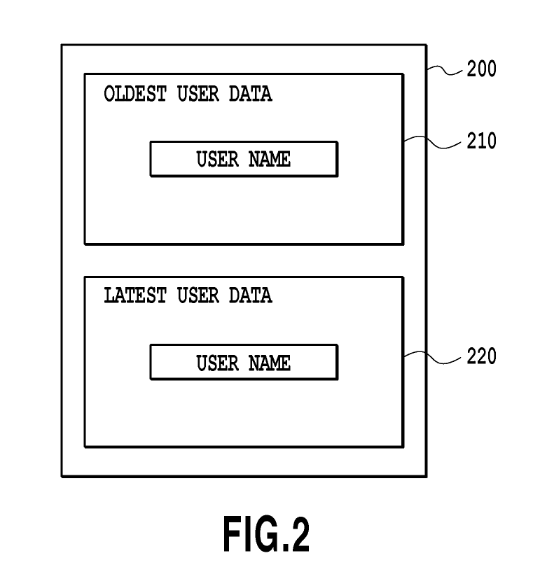

FIG. 2 is a diagram illustrating an example of the configuration of user history data 200. The user history data 200 includes two types of information, that is, oldest user data 210 and latest user data 220. As the user information, the user name is included both in the data 210 and 220, and they are stored in the storage section 702 of the image forming apparatus as the user history data. The stored user history data is combined with print data as a code image during printing, which will be described later, and printed on a paper medium as a code.

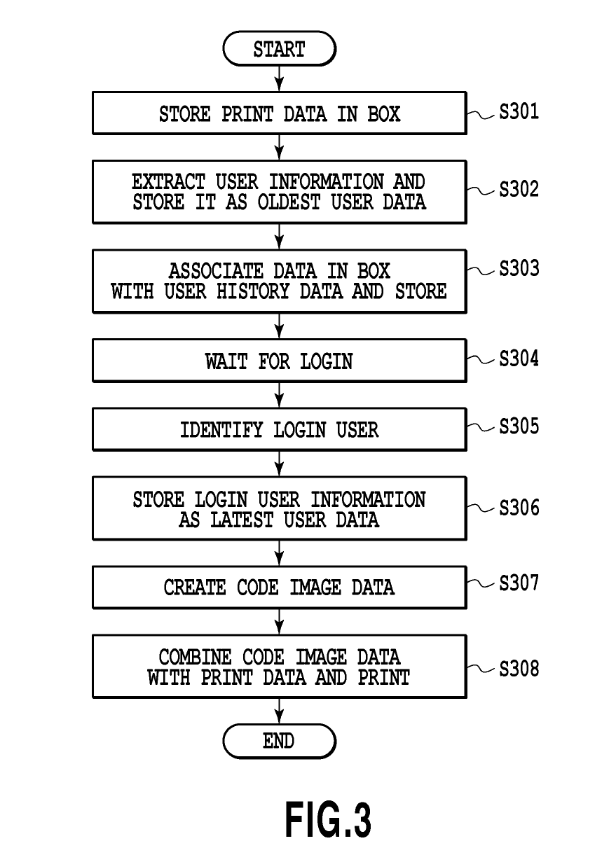

FIG. 3 is a diagram illustrating a processing flow in which the control section 701 of the image forming apparatus stores the print data transmitted from the PC in the storage section 702 and then, prints the stored print data by the printing section 704. The function of storing the print data once in the storage section 702 of the image forming apparatus to be printed later when necessary is called a box function. Also, the storage section 702 in which the print data is stored is simply called a box in some cases. Thus, in this embodiment, too, they might be called the box function or a box. The processing illustrated in FIG. 3 can be realized when the control section 701 executes the program stored in the storage section 702 of the image forming apparatus.

At Step S301, the control section 701 stores, in the storage section 702, the print data sent from a printer driver of the PC together with a storage instruction, which is an instruction to store it in the box. The print data sent to the image forming apparatus is added with user information such as a user ID, for example, of the user who is using the PC. At Step S302, the control section 701 extracts the user information added to the print data and stores the extracted user information as the oldest user data in the user history data in the storage section 702. That is, such processing is performed that the user history data having the user information added to the print data as the oldest user data is generated and stored in the storage section 702. The print data sent from the PC is data described in PDL (page description language), for example. Then, the PDL data is expanded into image data. The data to be stored in the storage section 702 may be data described in the above-described PDL or may be expanded image data.

At Step S303, the control section 701 associates the print data stored in the storage section 702 at Step S301 with the user history data stored in the storage section 702 at Step S302 and stores them in the storage section 702. By means of the above processing, the print data is brought into a so-called box-stored state.

The print data stored in the storage section 702 at Step S301 to Step S303 can be printed on a paper medium later by means of an instruction by a user different from the user who instructed the storage. Therefore, the user who instructed execution of the subsequent steps might be different from the user who instructed the storage, and the timing of execution is not limited to execution immediately after the storage.

Subsequently, at Step S304, the control section 701 enters a state in which the user's login in the image forming apparatus is awaited, and if the user's login is executed, the routine proceeds to Step S305.

At Step S305, the control section 701 identifies the login user of the image forming apparatus and receives a print instruction by the login user for the print data stored at Step S301 from the operation section 703 of the image forming apparatus.

Subsequently, at Step S306, the control section 701 reads out and updates the user history data stored in association with the print data thereof at Step S303. Specifically, the user history data is updated so that the information of the login user who made the print instruction for the print data stored at Step S301 is included in the latest user data in the read-out user history data. As a result, the user history data includes both the oldest user data and the latest user data. Then, the updated user history data is stored in the storage section 702.

At Step S307, the control section 701 reads out the user history data updated at Step S306 and encodes the user history data so as to generate code image data. The code image data refers to encoded image data and here means image data in which information including at least user history data has been encoded. The code image data may include information indicating prohibition or permission of output such as copying and transmission other than the above.

At Step S308, the control section 701 causes the printing section 704 in the image forming apparatus to print image data obtained by combining the generated code image data with the print data.

As a result, if printing is to be performed after the print data transmitted from the PC is accumulated in the box, the following information is set as the user history data. That is, as the oldest user data, the user information of the user who instructed box storage of the print data using the PC is set, and as the latest user data, the user information of the user who instructed printing is set.

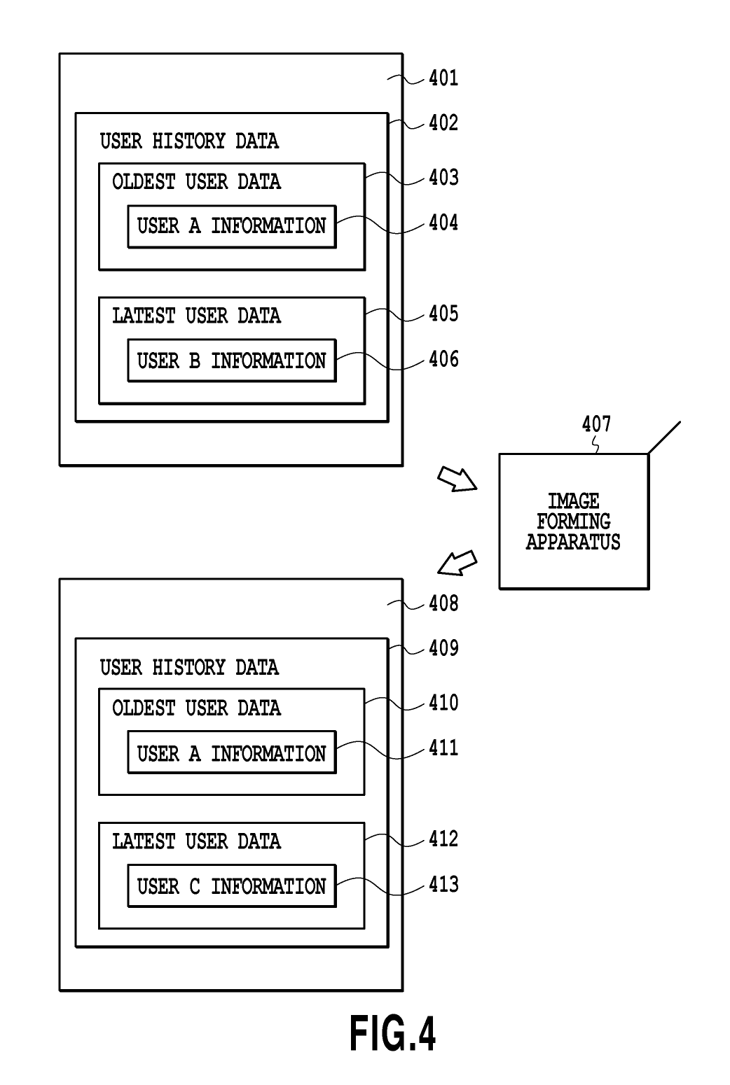

FIG. 4 is a diagram illustrating transition of the user history data if a printed matter using the print data including the code image data obtained by encoding the user history data created in the processing flow in FIG. 3 is copied.

In this example, the user history data included in the printed matter includes the information of a user A who instructed box storage as the oldest user data and the information of a user B who instructed printing of the print data stored in the box as the latest user data. The case in which this printed matter is copied by the image forming apparatus 407 as a document 401 will be described.

On the document 401, the encoded user history data 402 is printed. User A information 404 as the oldest user data 403 of the encoded user history data 402 and user B information 406 as the latest user data 405 of the encoded user history data 402 are recorded, respectively. Here, assume that a user C logs in the image forming apparatus 407 and copies the document 401 by using the image forming apparatus 407. In this case, as indicated in a document 408 after the copying, the latest user data 405 in the user history data 409 is deleted. Then, information 413 of the user C who instructed the copying is recorded as the latest user data 412 of the user history data. After that, similarly to the above, the information of a user who instructed copying is recorded as the user data 412 of the latest user history data.

The case in which the user who instructed box storage of the print data is different from the user who instructed printing of the print data stored in the box was described in the example in FIG. 4, but the both users may be the same. For example, in the example in FIG. 4, if the user A, who is the same user as the one who instructed box storage, makes the print instruction of the print data stored in the box, the user A information is included in both the oldest user data 403 and the latest user data 405.

As described above, in this embodiment, if user information is to be newly recorded, halfway information is deleted, and the new user information is recorded as the latest information. Then, the latest information and the oldest information are embedded in the document after copying as the user history data. Therefore, the latest user information is updated to the information of a user who performed copying/printing, while the information of the user who instructed box storage remains as the oldest user data. As a result, the information of the user who caused an increased risk of information leakage in the first place by instructing the box storage can be held, and the source of the information leakage can be correctly identified.

In the above description, a method of setting the information of a user who instructed box storage as the oldest user information if the print data is transmitted from the PC so as to be stored in the box of the image forming apparatus is described. However, exceptionally, it might be better that the information of the user who instructed box storage is not held in some cases. That is, when the user information is stored in a box with authentication. An example of the box with authentication is a box with a password.

The box with a password has a mechanism in which an arbitrary password is set for the box, and if data in the box is to be accessed, an input of the password is requested, and only if the password matches, the data can be accessed. If the print data is stored in the box with a password, the print data is protected by the password at the time of the storage. Therefore, at this time, viewing or use of the data is restricted. That is, a so-called closed state is maintained. Thus, it can be assumed that a user who stored the print data in the box with a password does not conduct an act of increasing a risk of information leakage. Instead, the user who created a paper medium as a printed matter from the box with a password can be regarded as a person who conducted an act of increasing the risk of information leakage, that is, who changed the closed state to an open state.

Thus, in order to correctly identify the source of information leakage, not the information of the user who instructed storage in the box with a password (that is, a user who performed digitization) but the information of the user who conducted the act of increasing the risk of information leakage should be set as the oldest user data. That is, the information of the user who instructed printing to create a paper medium should be set as the oldest user data.

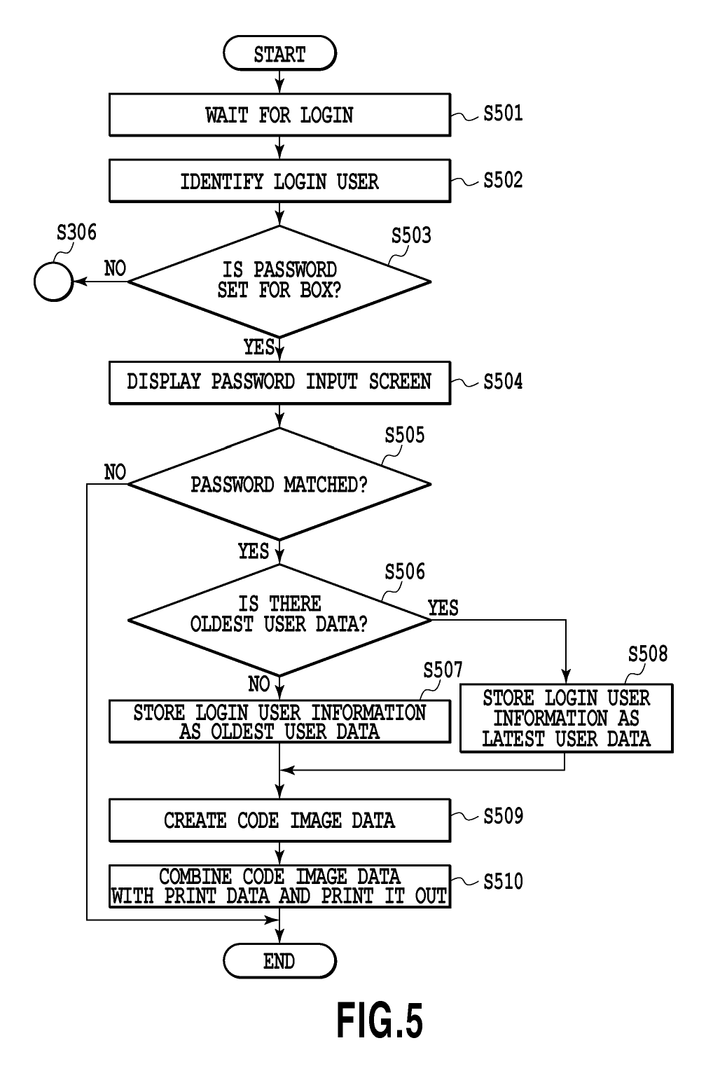

FIG. 5 illustrates a processing flow when the print data is stored in the box with a password and then, printing is performed. The processing flow illustrated in FIG. 5 can also be realized when the control section 701 executes the program stored in the storage section 702 of the image forming apparatus. Further, the processing of storing the print data in the box with a password is omitted from the processing flow illustrated in FIG. 5. If the print data sent from the PC is to be stored in the box with a password, the processing corresponding to the processing at Step S302 and the processing at Step S303 illustrated in FIG. 3 can be omitted. That is, the user information stored in the box with a password can be set not to be stored as the oldest user data. That is because the box with a password has restriction on viewing or use of data as described above, that is, in a so-called closed state. That is, the box storage with a password of the print data sent from the PC is considered to be processing while the closed state is maintained, and thus, the user who executed this processing is not set as the oldest user data. The password of the box is set in advance before the print data is stored in the box. The set password of the box can be encrypted by the control section 701 and stored in the storage section 702.

At Step S501, the control section 701 enters the state of awaiting user login for the image forming apparatus, and if login is executed, the routine proceeds to Step S502. At Step S502, the control section 701 identifies the user who logged in the image forming apparatus and receives a print instruction for the print data by the login user.

At Step S503, the control section 701 determines whether or not a password has been set for the box which stores the print data. If a password has been set, the routine proceeds to Step S504, while if not, the routine proceeds to Step S306 in FIG. 3.

At Step S504, the control section 701 makes the operation section 703 of the image forming apparatus display a screen which prompts password input. At Step S505, the control section 701 compares the password input and the password set in the box. If the passwords match each other, the routine proceeds to Step S506, while if not, the processing is completed.

At Step S506, the control section 701 reads out the user history data associated with the print data box-stored in the storage section 702 and determines whether the oldest user data has been set or not. If the print data stored in the box with a password is the print data sent from the PC, since there is no oldest user data, the routine proceeds to Step S507. On the other hand, if there is the oldest user data, the routine proceeds to Step S508. Here, the case in which the routine proceeds to Step S508 is, as will be described in an example later, a case when a document scanned by a scanner includes encoded user history data and also, the oldest user data is set therein, and also a case when the scanned document is stored in the box with a password.

At Step S507, the login user information is stored as the oldest user data. That is because, the information of the user who instructed printing on a paper medium, which is in a so-called open state, from the box with a password, which is in a so-called closed state, should be held as the oldest user data. Therefore, at Step S507, the control section 701 sets the information of the login user to the oldest user data in the user history data associated with the print data. As a result, the user information of the user who instructed printing of the print data stored in the box with a password becomes the oldest user data.

On the other hand, at Step S508, it is already determined that there is already the oldest login user in the Step S506. That is, the information of the user who has changed the state from the so-called closed one to the open one has been already set. Therefore, at Step S508, the information of the login user who instructed printing of the data stored in the box with a password is not set as the oldest user data but is stored as the latest user data.

At Step S509, the control section 701 reads out the user history data and encodes this user history data, thereby generating code image data. At Step S508, the control section 701 combines the generated code image data with the print data and causes the printing section 704 in the image forming apparatus to print the obtained image data.

As a result, the information of the user who executed the processing of storing the print data sent from the PC in the box with a password, that is, the user who maintains the closed state is not included in the oldest user data. On the other hand, if the data is printed after storage in the box with a password from the PC, a printed matter for which the information of the user who instructed printing, that is, changed the state from the closed one to the open one, is set as the oldest user data can be obtained. Regarding the user who executed the processing of storage in the box with a password from the PC, it can be left not to be set as the latest user data, either. That is because the latest user data is overwritten in printing.

As described above, when a box with authentication is to be used, the information of the user who instructed printing, which is an act of increasing the risk of information leakage, can be set as the oldest user data of the user history information. Also, when the information of the user who instructed printing, which is an act of increasing the risk of information leakage, has been already included, the information (that is, the oldest user data that has been set) can be maintained.

In the above-described example, the case in which the box with authentication is a box with a password is described. However, it is needless to say that authentication can be made by any authentication method other than the password. It is only necessary that the print data stored in the box cannot be accessed by all the users.

Further, in the above-described example, when the print data is to be stored in the box with authentication, the information of the user who performed the box storage is not set as the oldest user data of the user history data. However, such processing may be made that the information of the user who stored the print data in the box with authentication is temporarily set as the oldest user data and the oldest user data is overwritten by the information of the user who instructed printing of the print data. In this case, determination at Step S506 in FIG. 5 is changed to determination processing on whether the data is the data scanned by a scanner or not. Even if such processing is executed, the user history data renders the same result as the case described above.

In the above-described example, a case in which, if a printed matter including the encoded user history data is printed on a paper medium, printing is made after the print data transmitted from the PC is stored in the box is referred to.

In the following, a case in which a document is scanned by a scanner of the image forming apparatus and printing is performed after document image data, which is image data of the document obtained by scanning, is stored in the box will be described. This document image data can be also handled as print data in a wider sense.

The box storage of print data upon an instruction from the PC is an act of disclosure as electronic data into an image forming apparatus used by many people in an open state from a device owned by an individual in a so-called closed state. Therefore, as in the processing described in FIG. 3, the example in which the information of the user who made the disclosure as electronic data, that is, in a so-called open state is set as the oldest user data of the user history data was described.

On the other hand, the act of scanning the paper medium by a scanner in the image forming apparatus and disclosing it as electronic data is not considered to be an act of increasing the risk of information leakage. That is because a paper medium has been already present as a document and that is viewed or used by more people. That is, it is considered that the document (information) has already been in an open state.

From this viewpoint, the storage user who instructed storage of the document image data in the box is not considered to be a user who conducted a risky act of changing the state from a closed one to an open one. Therefore, the processing of setting the user who instructed box storage as the oldest user data is not executed but the information of the user who performed printing of the document image data stored in the box should be set as the oldest user data of the user history data. That is because the idea that the information of the user who printed/copied should be basically placed in the oldest user data and the latest user data is present as a premise as described above. Therefore, in the case of the box storage by scanning the paper medium which has already been in the open state, as described above, returning to the basic idea, the processing of placing the information of the user who printed/copied in the oldest user data or the latest user data. Specifically, if the oldest user data is not set for the data stored in the box, the user who instructed printing of the data is set as the oldest user data. On the other hand, if the code image data including the oldest user data has been already added to the paper medium as a document, the oldest user data is not overwritten even after the box storage. Since the user who conducted an act of increasing the risk of information leakage has been already identified, the source of the information leakage can be correctly identified. Thus, if the oldest user data has been already set, the oldest user data is used as it is. And the user who instructed printing of the data stored in the box is set to the latest user data.

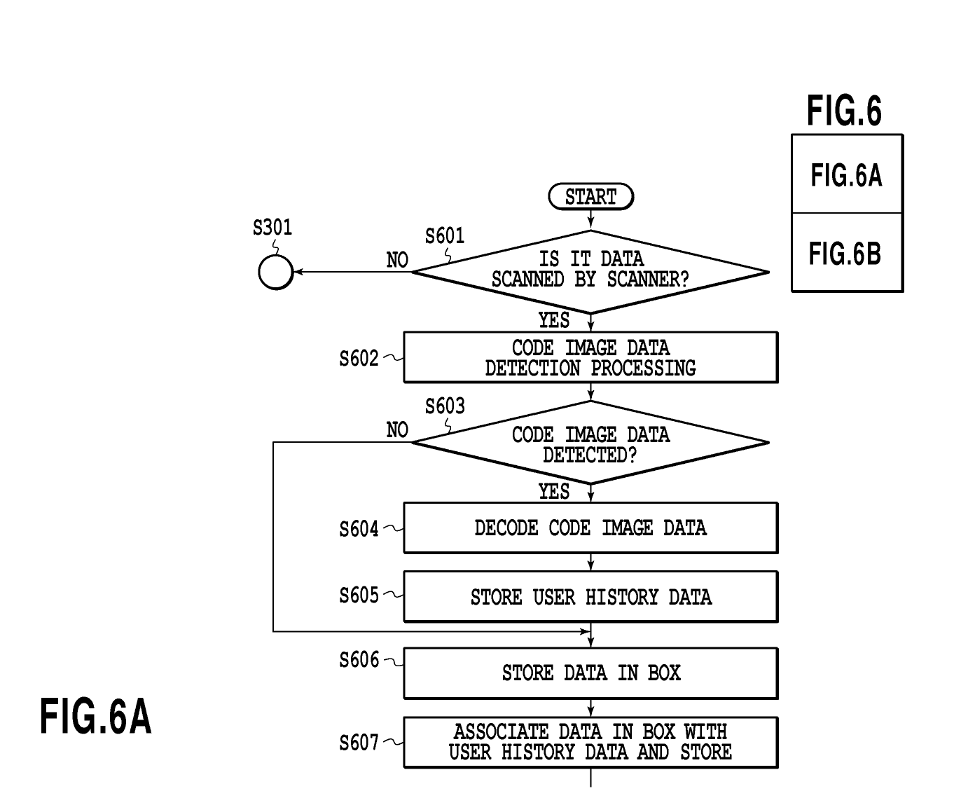

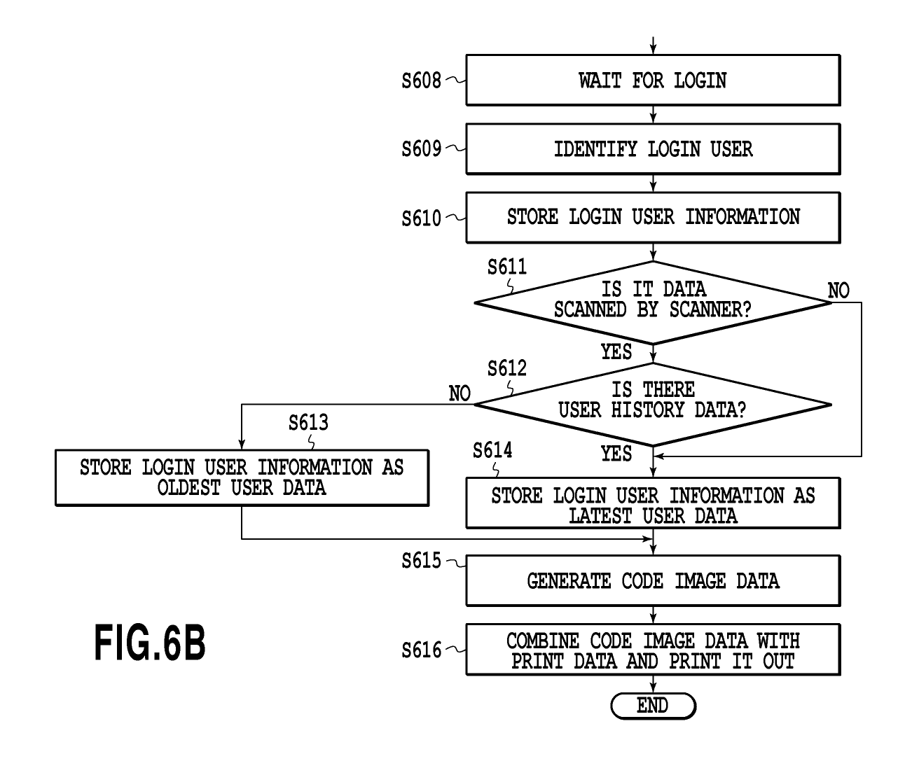

In FIGS. 6A and 6B, a processing flow is illustrated in which the control section 701 which controls the image forming apparatus has a scanner, which is the reading section 705 of the image forming apparatus, scans the document and stores the document image data in the box and then, printing is performed. The processing flow illustrated in FIGS. 6A and 6B can be also realized when the control section 701 executes the program stored in the storage section 702 of the image forming apparatus.

At Step S601, the control section 701 determined whether the data input into the image forming apparatus is data scanned by the scanner of the image forming apparatus or not. If it is the data scanned by the scanner, the routine proceeds to Step S602, while if it is not the data scanned by the scanner, then, it is determined to be data transmitted from a personal computer, and the processing at Step S301 and after in FIG. 3 is executed.

At Step S602, the control section 701 executes processing of detecting code image data included in the document image data. At Step S603, the control section 701 executes processing of determining whether the code image data is detected in the document image data or not. If the code image data is detected at Step S603, the processing proceeds to Step S604, while if the code image data is not detected, the processing proceeds to Step S606.

At Step S604, the code image data detected at Step S603 is decoded by the control section 701. As a result, the user history data included in the code image data can be obtained. At Step S605, the obtained user history data is stored in the storage section 702. At Step S606, the control section 701 stores the document image data in the box by using the storage section 702. At Step S607, the control section 701 associates the document image data stored in the box at Step S606 with the user history data and stores them if the user history data stored at Step S605 is present.

The print data stored in the storage section 702 similarly to FIG. 3 can be printed on a paper medium later by a user different from the user who performed the storage. Therefore, the user who executes the subsequent steps might be different from the user who performed the storage, and also, the timing of execution is not limited to execution immediately after the storage.

At Step S608, the control section 701 enters the state of awaiting user login for the image forming apparatus, and if login is executed, the routine proceeds to Step S609.

At Step S609, the control section 701 identifies the login user of the image forming apparatus and receives a print instruction from the operation section 703 by the login user of the document image data stored at Step S606. At Step S610, if the login user of the image forming apparatus makes a print instruction of the document image data in the box, the control section 701 stores the information of the login user in the storage section 702 as user data.

At Step S611, the control section 701 determines whether the data for which printing is instructed is data scanned by the scanner or not. If it is determined to be data scanned by the scanner, the routine proceeds to Step S612, while if it is not determined to be data scanned by the scanner, the routine proceeds to Step S614. The transition to Step S614 can be considered that the data is regarded as data transmitted from the PC. As described above, the apparatus temporarily might enter the standby state in the processing of awaiting login at Step S608, the determination processing is executed again at Step S611.

At Step S612, the control section 701 determines whether or not there is user history data associated with the document image data for which printing is instructed. If yes, the routine proceeds to Step S614, while if not, the routine proceeds to Step S613. At Step S613, the information of the login user stored at Step S610 is stored in the storage section 702 as the “oldest” user data in the user history data, and the routine proceeds to Step S615. That is, since the user history data is not included in the document image data scanned by the scanner, the user who instructed printing on a paper medium is stored as the oldest user data. On the other hand, at Step S614, the information of the login user stored at Step S610 is stored in the storage section 702 as the “latest” user data in the user history data. That is, the fact that the user history data is included in the document image data scanned by the scanner indicates that the information of the user who created the so-called open state has already been set in the oldest user data. Thus, the oldest user data is not updated but the information of the login user is stored as the latest user data.

At Step S615, the user history data taken out of the storage section 702 is read by the control section 701, and this user history data is encoded so as to generate code image data. At Step S616, the control section 701 causes the printing section 704 in the image forming apparatus to print the image data obtained by combining the generated code image data and the print data.

As a result, the information of the user who performed the processing of storing the document scanned by the scanner in the box, that is, the user who changed the state from the open one to the closed one is not included in the oldest user data. In this case, it can be set such that the user who performed the processing of storing the document scanned by the scanner in the box is not set as the latest user data, either. That is because the latest user data is overwritten in printing.

Further, the information of the user who performed the processing of storing the data scanned by the scanner in the box with a password, that is, the user who changed the state from the open one to the closed one is not included in the oldest user data, either. In this case, it can be set such that the user who performed the processing of storing the data scanned by the scanner in the box with a password is not set as the latest user data, either. That is because the latest user data is overwritten in printing.

As described above, if the document originally including the code image data is to be scanned by the scanner and printed, information to be newly included in the code image data can be added while at least a part of the information included in the code image data is held. That is, the information on the login user who instructed printing can be added. As a result, a printed matter is added with the encoded user history data including the oldest user data and the latest user data. The oldest user information at this time is on the user who conducted an act of increasing the risk of information leakage caused by creation of a paper medium, and thus, the source of the information leakage can be correctly identified.

The above description is based on assumption that the processing at each step in each flowchart is executed by one unit of the apparatus, but it is needless to say that the processing at each step may be executed by different apparatuses, respectively.

Further, the act of moving data stored in the box with a password to a usual box is also considered as an act of changing the state from a so-called open one to a closed one. Thus, it is possible that if the oldest user data is not set for the data, the information of the user who moved the data to the box is set as the oldest user data.

Further, in the above, the description was made on the example in which the print data stored in the box is printed in the same image forming apparatus. However, the print data stored in the box or the like may be transmitted together with the user history data associated with the print data or the like to another image forming apparatus. And it may be so configured that the printing processing is executed in another image forming apparatus after it is stored in the box in such another image forming apparatus. In this case, after the processing of storing the print data in the box at Step S301 in FIG. 3, it is determined whether or not there is user history data associated with the stored print data, and if there is user history data, the processing can be skipped to Step S304, for example. As a result, the print data transmitted from another image forming apparatus or the like can be stored in the box while the oldest user data is maintained. Also, the processing of transmitting the data to another image forming apparatus can be realized when the processing of transmitting the print data and the user history data associated therewith to another image forming apparatus is performed instead of the processing at Step S307 and Step S308 in FIG. 3, for example.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-262483, filed Nov. 25, 2010, which is hereby incorporated by reference herein in its entirety.

What is claimed is:

1. An apparatus having a control unit configured to cause a storage unit to store image data in accordance with a storage instruction, which is an instruction to store the image data, and to cause a printing unit to print the image data in accordance with a print instruction, which is an instruction to print the image data stored in the storage unit, wherein
the control unit causes the printing unit to print, together with the image data, code image data which includes information identifying a user who made the storage instruction and information identifying another user who made the print instruction.

2. The apparatus according to claim 1, wherein
the control unit causes the printing unit to print code image data which includes the information identifying a user who made the storage instruction as the oldest information and includes the information identifying a user who made the print instruction as the latest information.

3. The apparatus according to claim 1, wherein
when authentication is required for processing of the image data stored in the storage unit, the control unit causes the printing unit to print code image data which includes the information identifying a user who made the print instruction, instead of the information identifying a user who made the storage instruction.

4. The apparatus according to claim 1, wherein
when the image data instructed to be stored is document image data obtained by a reading unit, the control unit causes the printing unit to print code image data which includes the information identifying a user who made the print instruction, instead of the information identifying a user who made the storage instruction.

5. A control method in an apparatus having a control unit configured to cause a storage unit to store image data in accordance with a storage instruction, which is an instruction to store the image data, and to cause a printing unit to print the image data in accordance with a print instruction, which is an instruction to print the image data stored in the storage unit, the method comprising the step of
causing the printing unit to print, together with the image data, code image data which includes information identifying a user who made the storage instruction and information identifying another user who made the print instruction.

6. A program stored in a computer-readable storage medium for causing a computer to execute the control method according to claim 5.
